(19) United States
(12) Patent Application Publication
(10) Pub. No.: US 2013/0067417 A1
(43) Pub. Date: Mar. 14, 2013

(54) Presenting Hierarchical Information Items

(71) Applicants: Rasmus Mathias Andersson, San Francisco, CA (US); Rose Yao, San Francisco, CA (US); Erick Tseng, San Francisco, CA (US)

(72) Inventors: Rasmus Mathias Andersson, San Francisco, CA (US); Rose Yao, San Francisco, CA (US); Erick Tseng, San Francisco, CA (US)

(21) Appl. No.: 13/229,303

(22) Filed: Sep. 9, 2011

(51) Int. Cl. G06F 3/048

(52) U.S. Cl. 715/854

(57) ABSTRACT

In one embodiment, display a plurality of first information items, wherein: a hierarchy of information items comprises the plurality of first information items; each non-root information item in the hierarchy has a parent information item; and each non-leaf information item in the hierarchy has one or more child information items. Receive a first user interaction in connection with a first one of the plurality of first information items. In response to the first user interaction, if the first one of the plurality of first information items is a non-leaf information item in the hierarchy, then expand the first one of the plurality of first information items by displaying one or more second information items that are child information items of the first one of the plurality of first information items.

### TECHNICAL FIELD

This disclosure generally relates to presenting information items organized in hierarchies.

### BACKGROUND

Certain types of electronic devices, especially mobile or handheld devices such as mobile or smart telephones and notebook or netbook computers, have relatively small displays due to the relatively small sizes of the devices themselves. Consequently, not much information can be presented within such a small display area concurrently. There are different designs that help organize and display multiple information items within a relatively small display area. For example, a large set of information items may be divided into multiple subsets, each containing a small number of information items. Each subset of information items is displayed on a different screen, and a user may page through multiple screens to review multiple subsets of information items.

### SUMMARY

This disclosure generally relates to presenting information items organized in hierarchies.

In particular embodiments, display a plurality of first information items, wherein: a hierarchy of information items comprises the plurality of first information items; each non-root information item in the hierarchy has a parent information item; and each non-leaf information item in the hierarchy has one or more child information items. Receive a first user interaction in connection with a first one of the plurality of first information items. In response to the first user interaction, if the first one of the plurality of first information items is a non-leaf information item in the hierarchy, then expand the first one of the plurality of first information items by displaying one or more second information items that are child information items of the first one of the plurality of first information items.

These and other features, aspects, and advantages of the disclosure are described in more detail below in the detailed description and in conjunction with the following figures.

### BRIEF DESCRIPTION OF THE DRAWINGS

FIG. 1 illustrates an example method for presenting information items organized in a hierarchy.

FIG. 2 illustrates a portion of an example hierarchy of information items.

FIGS. 3-7 illustrate example presentations of information items organized in a hierarchy.

FIG. 8 illustrates an example computer system.

### DESCRIPTION OF EXAMPLE EMBODIMENTS

This disclosure is now described in detail with reference to a few embodiments thereof as illustrated in the accompanying drawings. In the following description, numerous specific details are set forth in order to provide a thorough understanding of this disclosure. However, this disclosure may be practiced without some or all of these specific details. In other instances, well known process steps and/or structures have not been described in detail in order not to unnecessarily obscure this disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

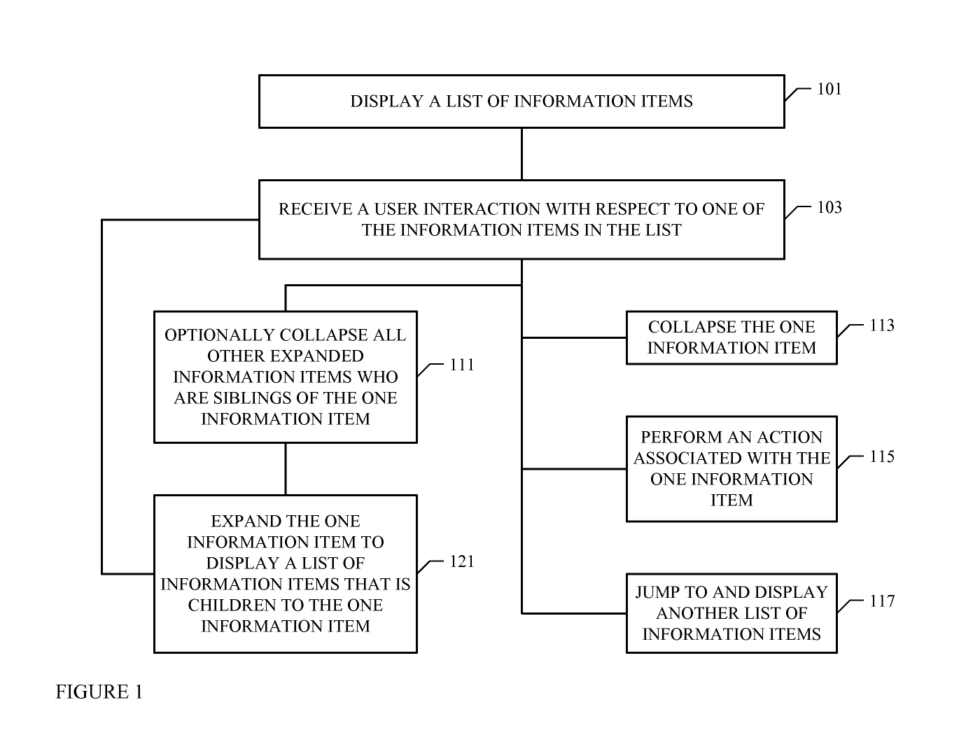

In particular embodiments, information items organized in a hierarchy are displayed on a mobile device. When a user interacts with (e.g., selects or clicks on) a specific information item, that information item is expanded so that its child nodes or elements are displayed. The user does not need to page through multiple screens. When an information item is expanded, its children are displayed on the same screen where the information item itself is displayed. FIG. 1 illustrates an example method for presenting information items organized in a hierarchy (e.g., on mobile devices).

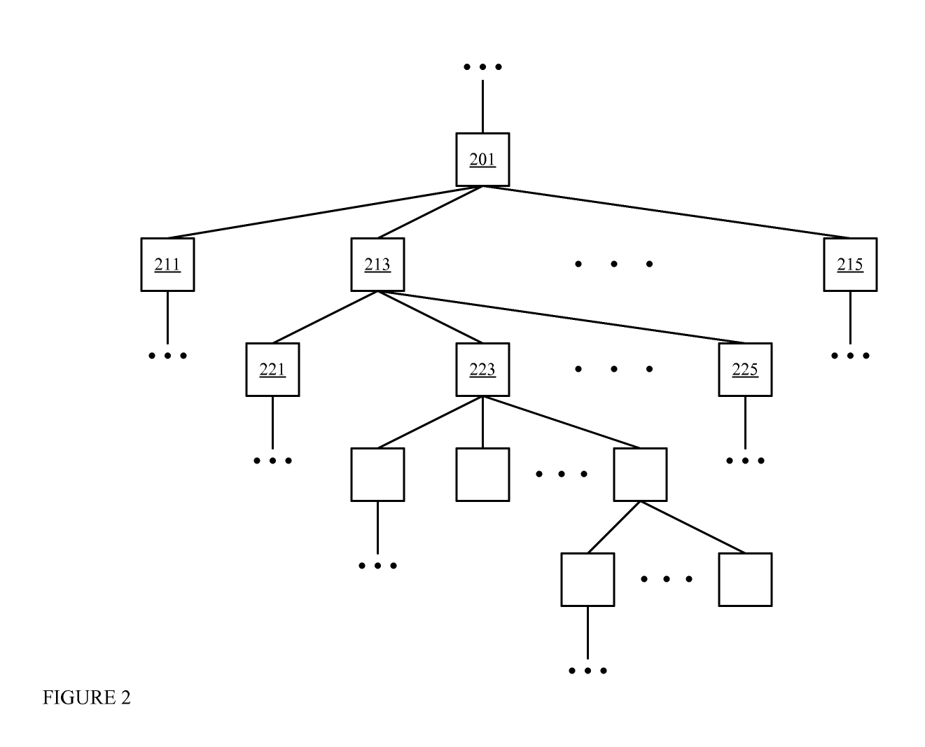

Any number (i.e., two or more) of information items may be organized into a hierarchy, which may indicate various relationships between the individual information items. As an example, FIG. 2 illustrates a portion of a hierarchy. In this case, each node may correspond to a specific information item. There may be any number of levels in a hierarchy, and any number of nodes at each level. Each node, except the root node, has a parent node. Thus, each information item, except the one corresponding to the root node, has a parent information item. Each node, except the leaf nodes, may have any number of children. Thus, each information item, except the ones corresponding to the leaf nodes, may have any number of child information items. In addition, when two nodes share the same parent, they are considered siblings of each other. In FIG. 2, with respect to node 213, node 201 is its parent, nodes 211 and 215 are its siblings, and nodes 221, 223, and 225 are its children. Note that any portion of a large hierarchy is itself a hierarchy.

There may be various types of information items, and this disclosure contemplates any applicable type of information items. For example and without limitation, an information item may be an email, a message, a notification, a post, a web page, a clickable link, an icon, a news story, a search result, an action, a user, an image, a video, a telephone number, an address, and so on. A hierarchy may consist of a collection of information items all of the same type (e.g., a hierarchy of emails, a hierarchy of notifications, a hierarchy of contact information) or a combination of information items of different types (e.g., a hierarchy of emails, messages, news stories, and notifications).

To present a hierarchy of information items on a mobile device (e.g., a mobile or smart telephone or a netbook or notebook computer), particular embodiments may display a list of information items, as illustrated in STEP 101. It is not necessary that the presentation always starts with the root of the hierarchy, although it can. When applicable, the presentation may start at any level in the hierarchy. For example, the list of information items may be a set of siblings that shares a common parent (e.g., nodes 211, 213, and 215) at a specific level in the hierarchy.

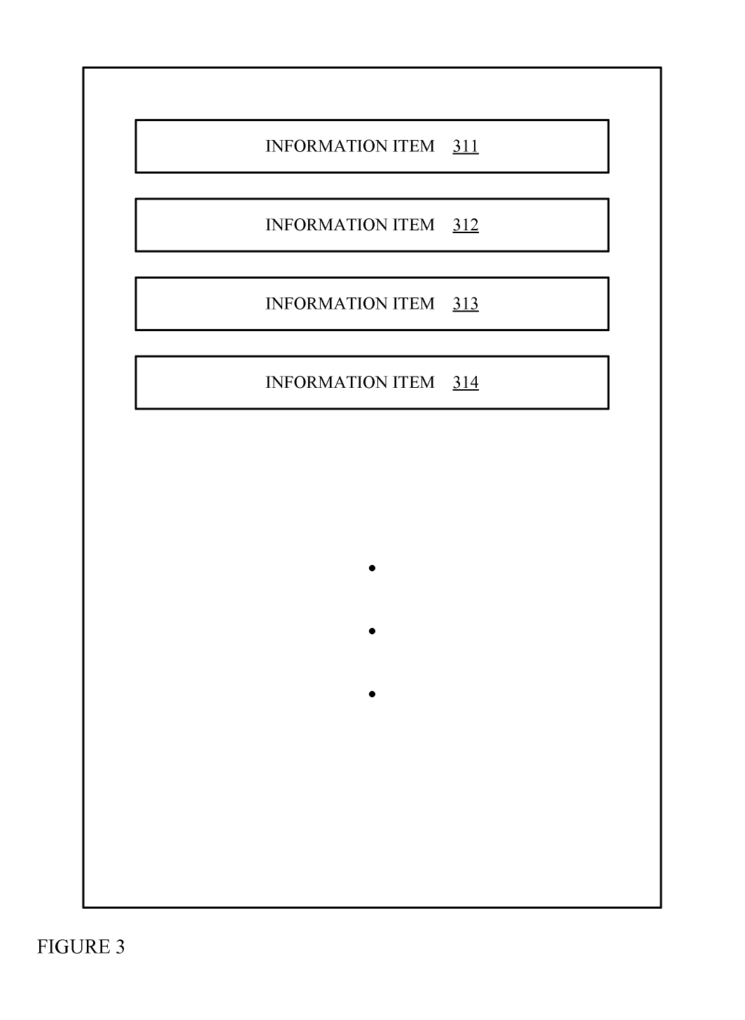

FIG. 3 illustrates an example presentation of a list of information items (e.g., information items 311, 312, 313, 314, . . . ). There may be any number (i.e., one or more) of information items in the list, as a parent may have any number of children. In particular embodiments, an information item may be represented as image, text, icon, clickable link, etc., or a combination thereof. In additional, in particular embodiments, an information item, whether corresponding to a non-leaf node or a leaf node, may be associated with one or more calls-to-action. A call-to-action corresponds to a specific action the user may perform in connection with the information item. In particular embodiments, each call-to-action associated with an information item may be represented as a clickable icon, which may be displayed in close proximity of the information item. The user may click the icon to cause the corresponding action to be performed. In particular embodiments, when the list of information items (e.g., information items 311, 312, 313, 314, . . . ) is displayed on a screen of a client device (e.g., a mobile device), the information items may consume approximately the entire width of the display screen. Similarly, when the list of information items is displayed within a designated area on a screen of a client device (e.g., a mobile device), the information items may consume approximately the entire width of the designated area of the display screen.

Suppose that a user interacts with one of the information items (e.g., information item 312) by, for example, clicking or tapping on it, as illustrated in STEP 103. Mobile devices provide various methods that enable their users to provide inputs to the devices. For example, some mobile devices incorporate touch-sensitive screens so that their users may provide inputs by touching the screens with their fingers or styluses. Other mobile devices incorporate keys or trackballs, which may be used to provide user inputs. This disclosure contemplates any applicable means to provide user inputs to mobile devices.

Depending on the nature, type, or current state of information item 312 as well as its siblings, the user interaction may result in several different responses.

First, if information item 312 has any child (i.e., corresponds to a non-leaf node) and is currently in collapsed form, then information item 312 may be expanded so that its children may be displayed. In some implementations, among a set of siblings that shares a common parent, only one sibling can be expanded at a time. In this case, if any sibling of information item 312 is currently in expanded form, that sibling is automatically collapsed, as illustrated in STEP 111. Alternatively, in other implementations, among a set of siblings that shares a common parent, any number of siblings may be expanded at the same time. In this case, there is no need to collapse any sibling of information item 312, even if the sibling is currently in expanded form, and STEP 111 is not performed. Alternatively, in yet other implementations, given a set of information items at the same level of the hierarchy, only one information item can be expanded at a time, regardless of whether or not these information items are siblings and share a common parent. In this case, if any information item at the same level of the hierarchy as information item 312 is currently in expanded form, that information item is automatically collapsed.

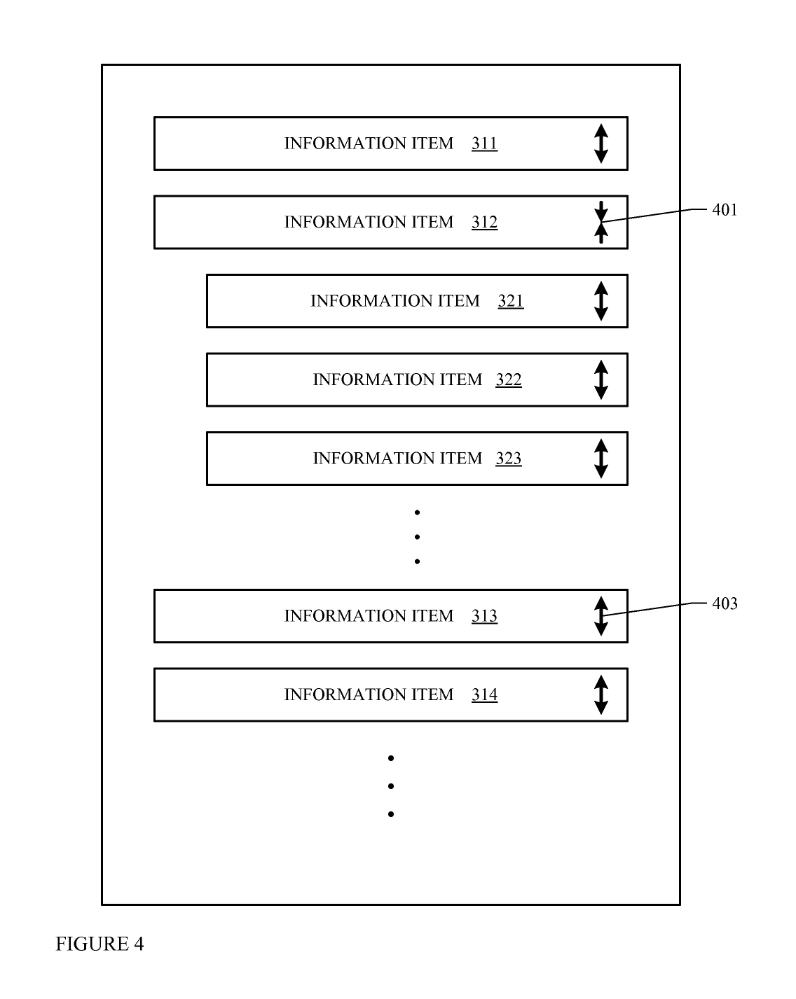

Information item 312 is expanded and each of its children is displayed, as illustrated in STEP 121. FIG. 4 illustrates an example presentation where information item 312 has been expanded and its children, information items 321, 322, 323, . . . , are displayed. The children of information item 312 are displayed (i.e., inserted) between information item 312 and information item 313, which immediately follows information item 312 in FIG. 3. To make room for the children of information item 312, those information items that follow information item 312, including information items 313 and 314, are pushed further down the display. Again, in particular embodiments, when the hierarchy of information items (e.g., information items 311, 312, 321, 322, 323, 313, 314, . . . ) is displayed on a screen of a client device (e.g., a mobile device), the information items may consume approximately the entire width of the display screen. Similarly, when the hierarchy of information items is displayed within a designated area on a screen of a client device (e.g., a mobile device), the information items may consume approximately the entire width of the designated area of the display screen.

The following example pseudo code illustrates expanding an information item and displaying its children. This example assumes that among a set of siblings sharing a common parent, only one sibling (i.e., one information item) can be expanded at a time.

// performed upon expanding an information item
on expand:

// collapse all siblings of the information item
for each sibling:

sibling.collapse( )

// display all children of the information item
for each child:

child.show()

// indicates whether an information item should
// display itself and its children
if (parent is expanded)

return TRUE;

else

return FALSE;

In particular embodiments, an icon is associated with each information item, which indicates whether it is currently in the expanded or collapsed form. For example, in FIG. 4, information item 312 is currently in the expanded form. Icon 401 is associated with information item 312. The user may click on icon 401 to collapse information item 312. On the other hand, information item 313 is currently in the collapsed form. Icon 403 is associated with information item 313. The user may click on icon 403 to expand information item 313.

Once information item 312 is expanded and its children, information items 321, 322, 323, . . . , are displayed, the user may interact with any one of the children, similarly as the user interacting with the parent. The children form another list of information items at another level of the hierarchy, and the steps illustrated in FIG. 1 may be similarly applied at that level of the hierarchy.

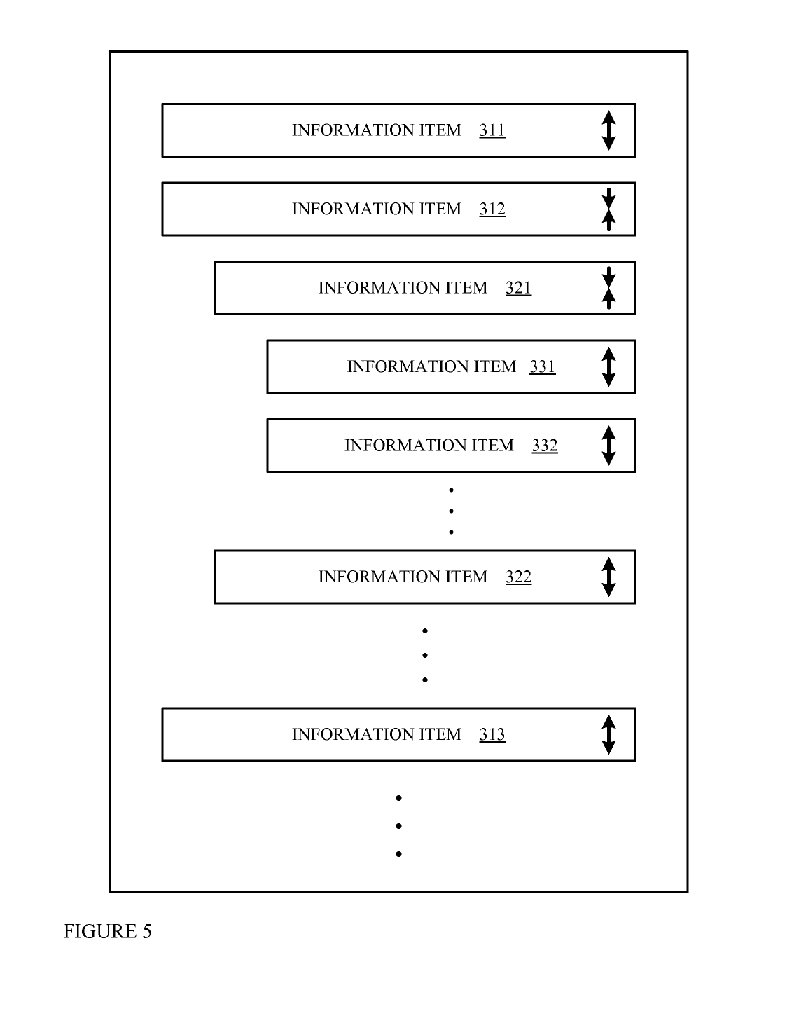

For example, suppose that the user clicks or taps on information item 321, which is one of the children of information item 312. Depending on the nature, type, or current state of information item 321 as well as its siblings, the user interaction may result in several different responses. The responses are similar to those of information item 312. For example, if information item 321 has any child and is currently in collapsed form, then information item 321 may be expanded so that its children, information items 331, 332, . . . , may be displayed, as illustrated in STEP 121. Again, in some implementations, among a set of siblings sharing a common parent, only one sibling can be expanded at a time. In this case, all siblings of information items 321, including information item 322, are automatically collapsed, as illustrated in STEP 131 111. FIG. 5 illustrates an example presentation where information item 312 is expanded, and information item 321, a child of information item 312, is also expanded.

Second, if information item 312 is currently in expanded form, then information item 312 may be collapsed, as illustrated in STEP 113. For example, suppose that the first time the user interacts with information item 312, the interaction results in information item 312 being expanded and its children being displayed. The second time the user interacts with information item 312 again, the interaction may result in information item 312 being collapsed. The user may thus toggle between expanding and collapsing an information item.

Third, if information item 312 does not have any child (i.e., information item 312 is a leaf node), or if a call-to-action is associated with information item 312, an action associated with information item 312 may be performed, as illustrated in STEP 115. In particular embodiments, a leaf information item may be associated with an action. When the user interacts with such a leaf information item, the action associated with that leaf information item is performed.

Fourth, if information item 312 is associated with another list of information items, the new list of information items may be displayed, replacing the current list of information items, as illustrated in STEP 117. In particular embodiments, the other list of information items may also be a part of a hierarchy. In addition, the two lists of information items may belong to the same hierarchy or to different hierarchies. The user may thus jump between different hierarchies of information items.

In particular embodiments, an animated sequence may illustrate each transition. For example, when an information item is expanded or collapsed, the transition from one state to another may be illustrated using an animated sequence. In particular embodiments, data pre-fetching may be implemented to improve performance. For example, for each information item that is currently displayed, its children are pre-fetched into cache so that if and when the user interacts with a specific information item, its children are readily available to be displayed.

To further explain some of the steps illustrated in FIG. 1, consider the following examples.

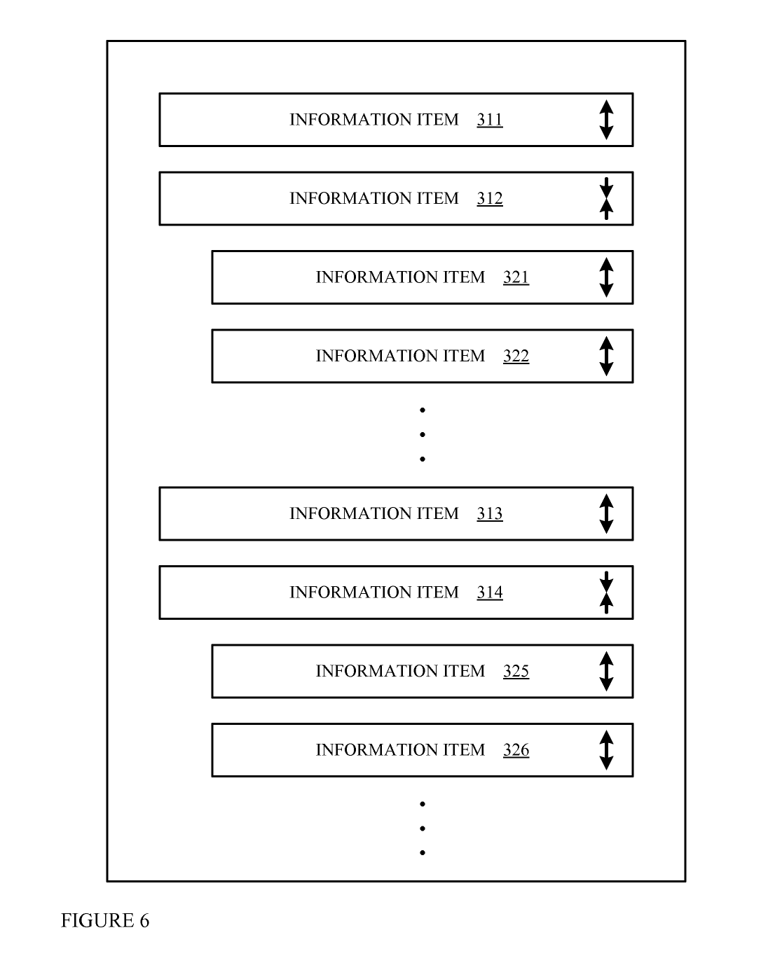

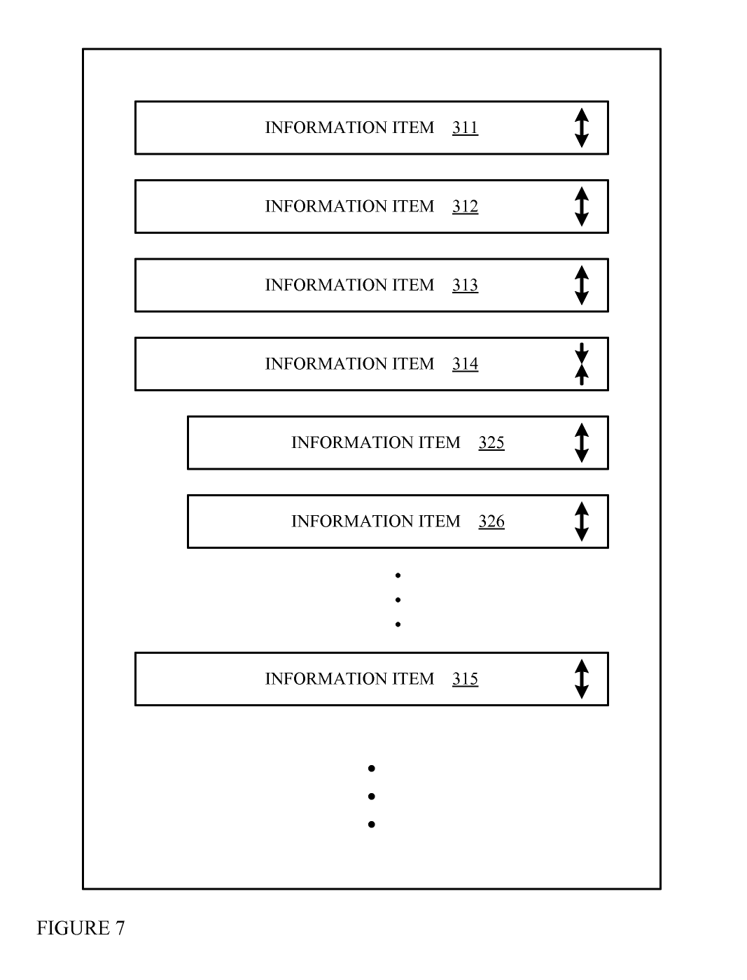

First, in FIG. 4, suppose that information items 311, 312, 313, 314, . . . , all share a common parent and thus are siblings. Information item 312 has been expanded. Further suppose that the user now interacts with information item 314 (e.g., by clicking or tapping on it), which causes information item 314 to be expanded as well and its children to be displayed. In some implementations, information item 312 is not automatically collapsed. Thus, both information items 312 and 314 are expanded, and their respective children are displayed at the same time, as illustrated in FIG. 6. Alternatively, in other implementations, information item 312 is automatically collapsed, and only information item 314 is expanded and its children are displayed, as illustrated in FIG. 7. In either case, the children of information item 314, information items 325, 326, . . . , are displayed immediately below information item 314. Those information items that are siblings of information item 314 but are displayed below information item (e.g., information item 315) are pushed further down to make room for the children of information item 314.

Second, for some types of information items, their children may be actions that users may perform in connection with the information item. As one example, an information item may be an email, and its children may include actions such as “read”, “reply”, “forward”, and “delete”. By expanding the email, the children that are actions that a user may perform in connection with the email may be displayed, and the user may interact with any one of the children to perform the corresponding action. As another example, an information item may be an invitation, and its children may include actions such as “accept”, “decline”, “tentative”, and “RSVP”. Again, by expanding the invitation, the children that are actions that a user may perform in connection with the invitation may be displayed, and the user may interact with any one of the children to perform the corresponding action. As a third example, an information item may be a person's name, and its children may be information about the person, such as his or her email address, telephone number, mailing address, etc. By expanding the person, the person's information may be displayed. The user may interact with a child to perform an action in connection with the person. For example, by interacting with the person's email address, the user may compose and send an email to the person; and by interacting with the person's telephone number, a call may be initiated to the person's telephone or the user may compose and send a text message to the person's telephone.

Third, some types of information items may be linked to other hierarchies of information items or other objects. As one example, an information item may be a link to a web page. When the user interacts with the link, the web page itself may be displayed, replacing all the currently displayed information items. As another example, an information item may be a news feed, which includes a collection of news stories arranged in another hierarchy. Expanding the news feed may cause the collection of news stories to be displayed, replacing all the currently displayed information items. The user may thus jump from a node in one hierarchy to another hierarchy. Similarly, an information item may be an address book, which includes a collection of names, telephone numbers, addresses, etc., arranged in a hierarchy. Expanding the address book may cause a list of names to be displayed, replacing all the currently displayed information items.

In particular embodiments, the information items may reside on the mobile device where they are displayed or may be retrieved or received from remote devices (e.g., servers or databases) via suitable communications networks. In particular embodiments, the user of the mobile device may be a member of an online social network. In this case, some of the information items may be information associated with the online social networking system. A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities. For example, the social-networking website operated by Facebook, Inc. at www.facebook.com enables its users to communicate with their friends via emails, instant messages, or blog postings, organize social events, share photos, receive news of their friends or interesting events, play games, etc. The user may receive messages, notifications, invitations, friend requests, etc., from other member of the online social network, and each of these may be an information item in the hierarchy.

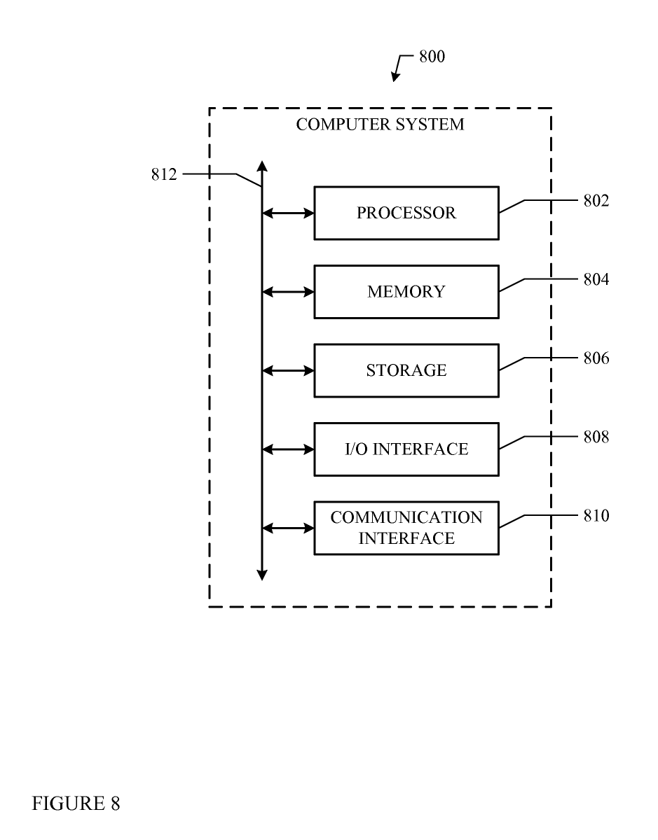

Particular embodiments may be implemented on one or more computer systems. FIG. 8 illustrates an example computer system 800. The information items may be displayed on a display screen coupled to computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 800 may include one or more computer systems 800; be unitary or distributed; span multiple locations; span multiple machines; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include an HDD, a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 802 (such as, for example, one or more internal registers or caches), one or more portions of memory 804, one or more portions of storage 806, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by a mobile device,
displaying a plurality of first information items, wherein:
a hierarchy of information items comprises the plurality of first information items;
each non-root information item in the hierarchy has a parent information item; and
each non-leaf information item in the hierarchy has one or more child information items;
receiving a first user interaction in connection with a first one of the plurality of first information items; and
in response to the first user interaction, if the first one of the plurality of first information items is a non-leaf information item in the hierarchy, then expanding the first one of the plurality of first information items, comprising displaying one or more second information items that are child information items of the first one of the plurality of first information items.

2. The method of claim 1, further comprising in response to the first user interaction, if one or more second ones of the plurality of first information items are expanded and share a common parent information item with the first one of the plurality of first information items in the hierarchy, then collapsing each one of the one or more second ones of the plurality of first information items so that no child information item of any one of the one or more second ones of the plurality of first information items is displayed.

3. The method of claim 1, further comprising in response to the first user interaction, if the first one of the plurality of first information items is a leaf information item in the hierarchy, then performing an action associated with the first one of the plurality of first information items.

4. The method of claim 1, further comprising in response to the first user interaction, if the first one of the plurality of first information items is linked to an object, then displaying the object, replacing the plurality of first information items.

5. The method of claim 4, wherein the object is a web page, or another hierarchy of information items.

6. The method of claim 1, further comprising in response to the first user interaction, if the first one of the plurality of first information items is associated with a call-to-action and the first user interaction is with respect to the call-to-action, then performing an action associated with the call-to-action.

7. The method of claim 1, further comprising:
receiving a second user interaction in connection with the first one of the plurality of first information items; and
in response to the second user interactions, collapsing the first one of the plurality of first information items so that no second information item is displayed.

8. The method of claim 1, further comprising:
receiving a second user interaction in connection with a second one of the plurality of first information items; and
in response to the second user interactions, if the second one of the plurality of first information items is a non-leaf information item in the hierarchy, then expanding the second one of the plurality of first information items, comprising displaying one or more third information items that are child information items of the second one of the plurality of first information items.

9. The method of claim 8, wherein:
the first one and the second one of the plurality of first information items share a common parent information item in the hierarchy; and
expanding the second one of the plurality of first information items further comprises collapsing the first one of the plurality of first information items so that no second information item is displayed.

10. The method of claim 1, further comprising:
receiving a second user interaction in connection with a first one of the one or more second information items; and
in response to the second user interaction, if the first one of the one or more second information items is a non-leaf information item in the hierarchy, then expanding the first one of the one or more second information items, comprising displaying one or more third information items that are child information items of the first one of the one or more second information items.

11. The method of claim 1, wherein the one or more second information items are respectively associated with one or more actions that can be performed with respect to the first one of the plurality of first information items.

12. The method of claim 1, wherein the one or more second information items are displayed in close proximity of the first one of the plurality of first information items.

13. The method of claim 1, wherein the mobile device is a mobile telephone.

14. A system comprising:
a memory comprising instructions executable by one or more processors; and
the one or more processors coupled to the memory and operable to execute the instructions, the one or more processors being operable when executing the instructions to:
display a plurality of first information items, wherein:
a hierarchy of information items comprises the plurality of first information items;
each non-root information item in the hierarchy has a parent information item; and
each non-leaf information item in the hierarchy has one or more child information items;
receive a first user interaction in connection with a first one of the plurality of first information items; and
in response to the first user interaction, if the first one of the plurality of first information items is a non-leaf information item in the hierarchy, then expand the first one of the plurality of first information items, comprising display one or more second information items that are child information items of the first one of the plurality of first information items.

15. The system of claim 14, wherein the one or more processors are further operable when executing the instructions to:
in response to the first user interaction, if one or more second ones of the plurality of first information items are expanded and share a common parent information item with the first one of the plurality of first information items in the hierarchy, then collapse each one of the one or more second ones of the plurality of first information items so that no child information item of any one of the one or more second ones of the plurality of first information items is displayed.

16. The system of claim 14, wherein the one or more processors are further operable when executing the instructions to:
in response to the first user interaction, if the first one of the plurality of first information items is a leaf information item in the hierarchy, then perform an action associated with the first one of the plurality of first information items.

17. The system of claim 14, wherein the one or more processors are further operable when executing the instructions to:
in response to the first user interaction, if the first one of the plurality of first information items is linked to an object, then display the object, replacing the plurality of first information items.

18. The system of claim 14, wherein the one or more processors are further operable when executing the instructions to:
in response to the first user interaction, if the first one of the plurality of first information items is associated with a call-to-action and the first user interaction is with respect to the call-to-action, then perform an action associated with the call-to-action.

19. The system of claim 14, wherein the one or more processors are further operable when executing the instructions to:
receive a second user interaction in connection with a second one of the plurality of first information items; and
in response to the second user interactions, if the second one of the plurality of first information items is a non-leaf information item in the hierarchy, then expand the second one of the plurality of first information items, comprising display one or more third information items that are child information items of the second one of the plurality of first information items.

20. One or more computer-readable non-transitory storage media embodying software operable when executed by one or more computer systems to:
display a plurality of first information items, wherein:
a hierarchy of information items comprises the plurality of first information items;
each non-root information item in the hierarchy has a parent information item; and
each non-leaf information item in the hierarchy has one or more child information items;
receive a first user interaction in connection with a first one of the plurality of first information items; and
in response to the first user interaction, if the first one of the plurality of first information items is a non-leaf information item in the hierarchy, then expand the first one of the plurality of first information items, comprising display one or more second information items that are child information items of the first one of the plurality of first information items.
